(19) United States
(12) Patent Application Publication
(10) Pub. No.: US 2005/0084179 A1
(43) Pub. Date: Apr. 21, 2005

(54) Method and apparatus for performing iris recognition from an image

(76) Inventors: Keith Hanna, Princeton Junction, NJ (US); Wenyi Zhao, Somerset, NJ (US); Yi Tan, Plainsboro, NJ (US)

Correspondence Address: MOSER, PATTERSON & SHERIDAN, LLP;/SARNOFF CORPORATION, 595 SHREWSBURY AVENUE, SUITE 100, SHREWSBURY, NJ, 07702, US

(21) Appl. No.: 10/939,943

(22) Filed: Sep. 7, 2004

Related U.S. Application Data
(60) Provisional application No. 60/500,088, filed on Sep. 4, 2003.

(51) Int. Cl. G06K 9/32

(52) U.S. Cl. 382/294

(57) ABSTRACT

A method and apparatus for performing iris recognition from at least one image is disclosed. A plurality of cameras is used to capture a plurality of images where at least one of the images contains a region having at least a portion of an iris. At least one of the plurality of images is then processed to perform iris recognition.

### CROSS-REFERENCE TO RELATED APPLICATIONS

This application claims benefit of U.S. provisional patent application Ser. No. 60/500,088, filed Sep. 4, 2003, which is herein incorporated by reference.

### GOVERNMENT RIGHTS IN THIS INVENTION

This invention was made with U.S. government support under contract number NMA401-02-9-2001. The U.S. government has certain rights in this invention.

### BACKGROUND OF THE INVENTION

Iris recognition is known as one of the most reliable means to identify an individual based on biometric information. Typical iris recognition systems utilize a single camera to obtain an image of the eye. Existing iris recognition systems require that the subject is stationary when acquiring iris images. In addition, most systems require that the subject self-position themselves in front of the iris recognition device. These constraints have severely limited the potentially wide deployment of iris recognition. Thus, one of the most challenging tasks of an iris recognition system is to make it work in a flexible environment.

Therefore what is needed in the art is a system and method capable of acquiring images in a dynamic environment for use in iris recognition.

### SUMMARY OF THE INVENTION

The present invention generally discloses a method and apparatus for performing iris recognition from at least one image. In one embodiment, a plurality of cameras is used to capture a plurality of images where at least one of the images contains a region having at least a portion of an iris. At least one of the plurality of images is then processed to perform iris recognition.

Also disclosed is a method and apparatus for forming a single image containing an iris from a plurality of images containing at least a portion of the iris. In one embodiment, the plurality of images is aligned over time. A subset of the plurality of images without artifacts is selected. The selected subset of images is then combined to produce a single image of the iris.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates an iris sensing and acquisition system according to one embodiment of the present invention;

FIG. 2 illustrates a diagram in accordance with a method of the present invention;

FIG. 3 illustrates an image process that combines multiple images according to one embodiment of the present invention; and

FIG. 4 illustrates a block diagram of an image processing device or system according to one embodiment of the present invention.

### DETAILED DESCRIPTION

The present invention discloses a system and method for acquiring images in a dynamic environment for use in iris recognition. The present invention allows people to move around while the tasks of iris capturing, processing and recognition are performed. In one embodiment of the present invention, a typical working scenario would involve a person walking toward a portal from a distance, detection of the person, capturing/matching the person's iris image, and invoking a positive or negative signal when the person passes through the portal, or within a reasonable time.

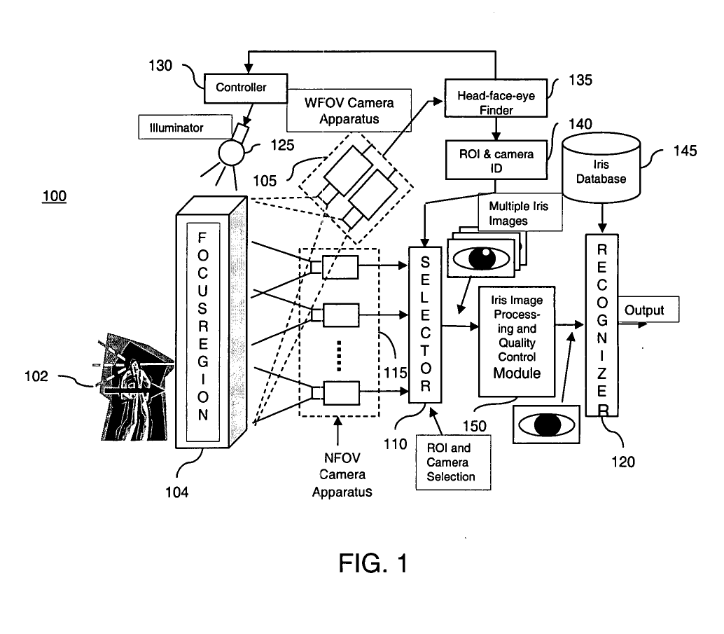

FIG. 1 illustrates an iris sensing and acquisition system 100 according to one embodiment of the present invention. An array of cameras 105, 115 captures a plurality of images within a focus region 104. At least one of the images captured by the array of cameras contains a region having at least a portion of an iris of a subject 102.

In one embodiment, a wide-field-of-view (WFOV) camera 105 detects faces, finds eyes and identifies the region-of-interest (ROI) for iris while allowing a subject 102 to move around. The ROI information is sent to a selector 110 to control the selection of an array of narrow-field-of-view (NFOV) camera(s) 115 for capturing a plurality of iris images. In one embodiment, the plurality of iris images comprises a sequence of high resolution iris images. The array of NFOV cameras 115 may comprise fixed and/or pan-tilt-zoom cameras. In addition, a depth map of the ROI may be automatically estimated to assist the selection of NFOV cameras 115. The depth estimation can be accomplished in many ways, e.g., stereo camera, infrared, ultrasound, ladar. To increase the system flexibility, NFOV cameras with increased capturing range can be used. In one embodiment, an array of NFOV cameras 115 may be operable to implement the present invention without the use of WFOV camera(s) 105.

As the captured iris image sequence is from a moving person, it is important for the system to process the images sufficiently, including for example, noise reduction, image composition, and feature enhancement. The processed iris pictures are then sent to an iris recognition module 120 for matching and identification. To actively improve the signal-to-noise ratio (SNR) and enhance the quality of an acquired iris image, an illumination device 125, such as active, invisible infrared LED lighting with shutter controller 130 may be used. In addition, image quality control module (IQCM) 150 selects or enhances an iris image by combining multiple input images before feeding them into iris recognition module 120.

A processed iris image is fed into the iris recognition module 120 for feature extraction, pattern matching, and person identification. One skilled in the art would recognize that the features of selector 110 and modules 135, 140, 150 of the present invention could be implemented by recognizer 120.

An iris model database 145 is provided for use in the matching process. Database 145 contains iris images or extracted pattern features. The data from the iris model database 145 is used for iris pattern matching with iris images obtained by recognizer 120.

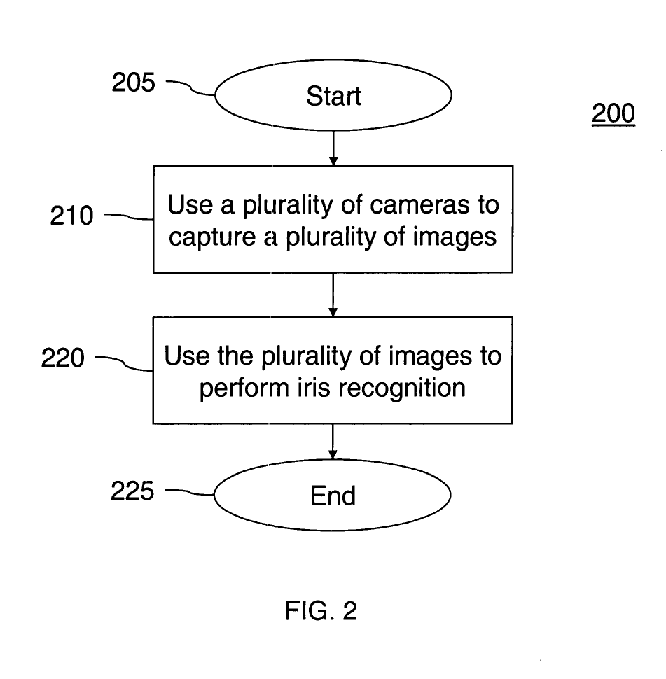

FIG. 2 illustrates a diagram in accordance with a method 200 of the present invention. Method 200 starts in step 205 and proceeds to step 210.

In one embodiment, the iris image capturing task is divided into two modules—iris sensing and iris acquiring. The iris sensing module monitors a designated spatial region for any activities using the WFOV stereo pair. If an individual appears in the scene, a head-face-eye finder 135 is activated to locate the eyes and estimate the ROI (and depth) of the eyes. A high resolution iris image is then acquired by a chosen NFOV camera selected based on the ROI (and depth) information supplied from the sensing module.

In step 210, a plurality of cameras is used to capture a plurality of images. At least one of the plurality of images captured by the plurality of cameras contains at least a portion of an iris.

To reliably match and identify an iris pattern, a picture of an iris typically should be at least 150 pixels in diameter. With average diameter of an iris about 1.0 cm, a conventional camera with 512×512 resolution can only cover a spatial area of 3.0×3.0 cm². In one embodiment, to overcome this limitation, an active vision system using WFOV cameras, an NFOV camera, and a pen/tilt unit may be used. However, this configuration uses slow mechanical motors, requires maintenance, and can significantly reduce the system response time. To overcome these limitations, the present invention uses a WFOV stereo camera pair and an array of static high resolution NFOV cameras to improve the spatial capturing range and the temporal response time (i.e., handling of human motion).

In one embodiment, a WFOV camera apparatus 105 catches and analyzes the wide field of view of the scene. Augmented with depth information (supplied from a separate depth detector or from the WFOV camera's own stereo image pair), the head-face-eye finder 135 detects the location of the head, face, and the eyes by searching through the images obtained from WFOV cameras 105.

The strategy for capturing an image of the iris is to first locate the head of the subject, then the face, and then the eye. This coarse-to-fine approach typically reduces image capture and processing requirements significantly. One such approach is to locate the subject at the closest depth (nearest) to the system and within the focus region. The depth of the user is recovered in real-time using stereo cameras. Subjects will be continually walking toward the portal and it would be necessary to ensure that a first subject will not be in front of the system and thereby obscuring the iris of a second subject. This can be accomplished using a study of the walking speed and separation distances of individuals, and by judicial placement of the system. For example, placement above the portal would ensure visibility in most circumstances.

The next step is to locate the position of the face. The face can be detected and tracked at a lower resolution compared to the iris, hence imposing much less constraint on image capturing and processing. The face can be detected using a generic face template comprising features for the nose, mouth, eyes, and cheeks. The position of the eye (recovered using the face detector) is then used to limit the ROI in which image capture and processing is performed to locate an image of the eye at the finer resolution that is required for iris recognition. Since the person is moving, a simple predictive model of human motion can be used in the hand-off from the coarse to fine resolution analysis in order to overcome latencies in the system. The model need not be accurate since it is used only to predict motion for the purpose of limiting image capturing and processing requirements.

WFOV lenses with appropriate aperture settings may be used. By using WFOV lenses, the WFOV stereo pair with conventional resolution is capable of covering a larger spatial region, such as a spatial cube ranging from 0.5 m×0.5 m×0.5 m to 1.0 m×1.0 m×1.0 m.

In one embodiment, to guarantee the sufficient coverage of a region, an array of NFOV high resolution cameras 115 are used. Since NFOV cameras have a much smaller depth of focus, the accurate estimate of depth is critical in acquiring high quality images. In one embodiment, depth information is obtained from the from the WFOV information. There are many methods for obtaining the depth information, i.e., using stereo cameras, time-of-flight (TOF) devices, infrared (IR) sensors, and ultrasonic sensors. To further improve the robustness of the system, some simple devices such as infrared-based occlusion detectors can be readily installed in a venue, e.g., a metal detector portal in an airport, to signal that the moving target is ready to enter a region of focus, e.g., focus region 104.

The calculated eye's ROIs (x, y, dx, dy) in the WFOV image are mapped into the local coordinate system on a NFOV camera array using ROI and camera ID module 140. The mapping results in new ROIs (cid, x′, y′, dx′, dy′) corresponding to an image in the NFOV cameras. The cid is the camera identifier for a camera in the NFOV array on which the iris is imaged. The mapping may be assisted by using the depth information. The mapping function may be obtained by a pre-calibration process in the form of a “Look-Up-Table” (LUT).

In the situation where an iris is located across the boundary on more than one NFOV camera, the WFOV apparatus is capable of specifying a sub ROI for each involved NFOV camera and sending the sub ROI to the NFOV apparatus for iris image acquiring.

The WFOV apparatus has motion tracking and stabilizing capability. This motion tracking and stabilizing capability may be used so that the motion of the head/face can be tracked and the ROIs for eyes can be updated in real-time.

A high resolution iris image is acquired by the NFOV camera apparatus. Using an array of high resolution cameras, the apparatus can cover a large sensing area so that the iris can be captured while the target is moving around.

The covering region depends on a camera's resolution, the viewing angle, and the depth of focus. In general, lenses used with high-resolution cameras will result in small depth-of-focus. Properly selecting the lenses for NFOV cameras allows for an extended focus range. To increase the capturing range, the present invention uses either 1) fast zooming lenses that could potentially increase the system response time, 2) multiple cameras covering overlapping areas especially along the Z-direction, or 3) a special optical encoder. Sufficient focus depth coverage guarantees the iris imaging quality while the target is moving towards or backwards from the NFOV cameras.

Mechanical lens focus mechanisms typically operate slowly. Therefore, a simple prediction model to set the lens focus at a series of “depth curtains” such that capture of fine resolution imagery of the iris is triggered once the subject passes through the depth curtain. The depth of the subject is recovered using real-time stereo analysis of the imagery from WFOV cameras.

An additional method for obtaining a focused image is to acquire multiple images as the person is walking through the depth curtain, and to select those images that are most in focus or produce a sharp image from a sequence of possibly blurry images.

The iris image acquisition on NFOV camera array 115 is ROI based. ROIs are generated from the WFOV camera module 105. Only pixels from ROI regions on NFOV cameras are acquired and transferred for further processing. The ROI-based iris image acquisition reduces system bandwidth requirements and adds the possibility for acquiring multiple iris images within a limited time period.

The NFOV selector module 110 takes the ROI information from the WFOV and associated depth information to decide which NFOV camera 115 to switch to and sets up a ROI for iris image acquiring. The module also generates a signal for illumination device 125 control. The illumination device may have a mixture of different wavelengths may have an “always on” setting or may be switched on and off in a synchronized manner with the camera shutter.

To cover an even larger area or reduce the system cost without significantly impacting the temporal response of the system, a combination of a tilt platform with a single row of a camera array may be a compromising solution. The row array of cameras covers a necessary horizontal spatial range for high-resolution image acquisition. The tilt platform provides one degree of freedom for cameras to scan irises for persons with different heights. In one embodiment, a mirror may be mounted on the platform to reflect images to the fixed camera row. In another embodiment, the camera row may be mounted on the platform directly. Since the mechanical portion has only one degree of freedom, the reliability will be increased.

In one embodiment, the NFOV apparatus also has the capability to directly detect faces/eyes. An array of NFOV cameras would be utilized. In this embodiment, each NFOV camera is operable to detect at least a portion of an iris in its respective field of view. In this embodiment, the NFOV array is operable to provide spatial coverage of a focus region. In addition, the NFOV array may be augmented with focal depth information. Focal depth information may be obtained from NFOV cameras using methods similar that of the WFOV apparatus. To ensure successful iris matching, a signal would be invoked only when eyes in good focus are detected. This can be achieved by applying a match filter along with certain user-designed specularity patterns.

In step 220, at least one of the plurality of images is processed to perform iris recognition. In one embodiment, processed iris images from the IQCM 150 are fed into the iris recognition module for feature extraction, pattern matching, and person identification. An iris model database 145 is provided for use in the matching process. The database contains iris images or extracted pattern features. The data from the iris model database 145 is used for iris pattern matching. Method 200 ends at step 225.

In one embodiment, controlled specularities are used to detect a pupil in a region of interest. As discussed in previous sections, one operational embodiment finds the head, then face, and then the eye using WFOV, and then uses NFOV to localize the iris. This operational embodiment is based on using normal images while abnormal image regions such as specularities are treated as outliers. However, the artifacts can be used if they can be controlled. For example, specularities have been used to find a human's pupil directly if the eyes are illuminated with near-infrared illuminators 125. By putting illuminators 125 along and off the camera axis, the bright-pupil effect and dark-pupil effect can be produced respectively. By turning two sets of illuminators on and off sequentially, reliable detection of bright pupils can be achieved without confusing those bright pupils with glints produced by corneal reflection of IR light.

Using controlled illuminators 125, the specularity can be used to detect the eye regions directly. Controlled illuminators 125 may also be integrated with the head-face-eye approach for speed and robustness within the WFOV and/or NFOV apparatus. In this embodiment, multiple light sources are modulated over time to help identify the location of the eye.

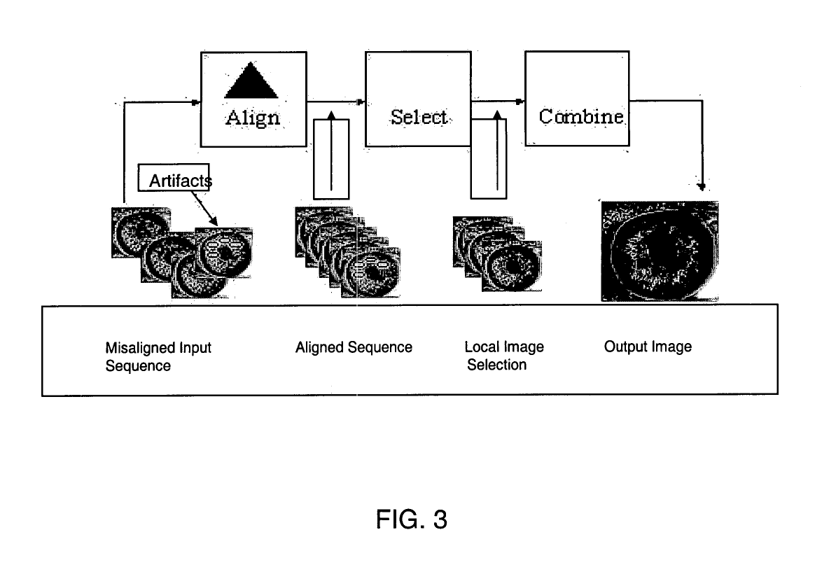

FIG. 3 illustrates an iris image enhancement process of the present invention. In one embodiment a plurality of iris images may be processed to form a single iris image. When multiple iris images are being acquired while an individual is on the move, the iris images need to be processed and selected before being sent to a recognition module. The image quality control module (IQCM) 150 handles this task. IQCM 150 first filters out the bad quality iris images—such as ones that are out of focus, incomplete, or have too many reflections. A group of qualified images is then processed to form a single high quality iris image. Iris localization is then performed by detecting the contours of the iris and pupil. This process involves image registration—to align the iris images over time, select portions of imagery without artifacts, and combine the remaining image portions to produce a single high quality image of the iris.

For image registration, the parametric model-based alignment can be used to register the images over time. The model complexity may vary depending on the time period over which the imagery is registered. For example, over very short periods of time, a simple affine model may be sufficient since very little motion will occur.

The IQCM 150 also has the capability to mosaic incomplete iris images that may be obtained from different NFOV cameras into a single complete image. This is often necessary as the system is operating in an unconstrained motion environment, where a person's iris could be located across image boundaries.

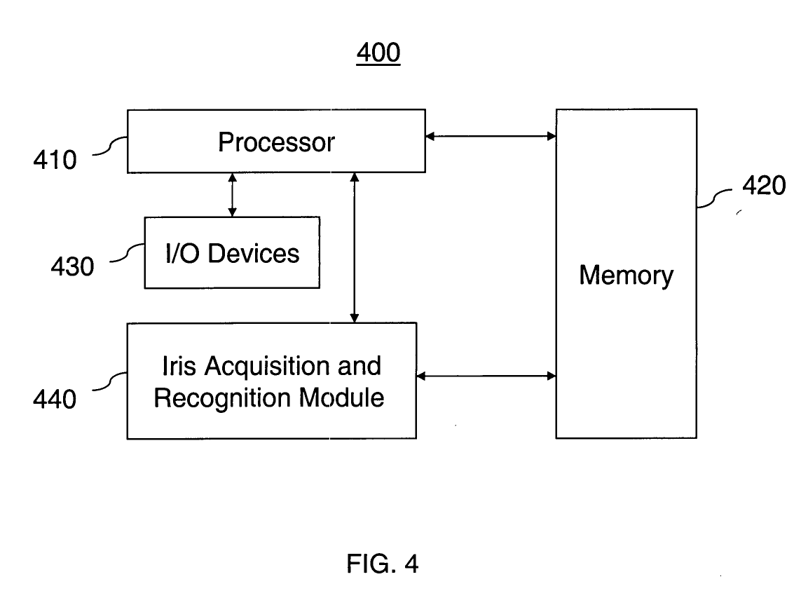

FIG. 4 illustrates a block diagram of an image processing device or system 400 of the present invention. Specifically, the system can be employed to process a plurality of images from a plurality of cameras to perform iris recognition. In one embodiment, the image processing device or system 400 is implemented using a general purpose computer or any other hardware equivalents.

Thus, image processing device or system 400 comprises a processor (CPU) 410, a memory 420, e.g., random access memory (RAM) and/or read only memory (ROM), an iris acquisition and recognition module 440, and various input/output devices 430, (e.g., storage devices, including but not limited to, a tape drive, a floppy drive, a hard disk drive or a compact disk drive, a receiver, a transmitter, a speaker, a display, an image capturing sensor, e.g., those used in a digital still camera or digital video camera, a clock, an output port, a user input device (such as a keyboard, a keypad, a mouse, and the like, or a microphone for capturing speech commands)).

It should be understood that the iris acquisition and recognition module 440 can be implemented as one or more physical devices that are coupled to the CPU 410 through a communication channel. Alternatively, the iris acquisition and recognition module 440 can be represented by one or more software applications (or even a combination of software and hardware, e.g., using application specific integrated circuits (ASIC)), where the software is loaded from a storage medium, (e.g., a magnetic or optical drive or diskette) and operated by the CPU in the memory 420 of the computer. As such, the iris acquisition and recognition module 440 (including associated data structures) of the present invention can be stored on a computer readable medium, e.g., RAM memory, magnetic or optical drive or diskette and the like.

While the foregoing is directed to embodiments of the present invention, other and further embodiments of the invention may be devised without departing from the basic scope thereof, and the scope thereof is determined by the claims that follow.

1. A method of performing iris recognition from at least one image, comprising:
using a plurality of cameras to capture a plurality of images of a subject where at least one of said images contains a region having at least a portion of an iris; and
processing at least one of said plurality of images to perform iris recognition.

2. The method of claim 1, wherein the plurality of cameras comprise at least one wide field of view camera for detecting a region of interest.

3. The method of claim 2, wherein said region of interest is mapped into a local coordinate system of a camera array.

4. The method of claim 1, wherein at least one of said plurality of cameras covers a spatial range that is different from at least one other camera of said plurality of cameras.

5. The method of claim 1, wherein at least one of said plurality of cameras covers a focus depth that is different from at least one other camera of said plurality of cameras.

6. The method of claim 1, wherein each image captured by the at least one camera is augmented with depth information.

7. The method of claim 6, wherein depth information is obtained using stereo cameras.

8. The method of claim 6, wherein depth information is obtained using at least one time-of-flight device.

9. The method of claim 6, wherein depth information is obtained using at least one infrared sensor.

10. The method of claim 6, wherein depth information is obtained using at least one ultrasonic sensor.

11. The method of claim 1, further comprising using an illuminator for illuminating said subject.

12. The method of claim 11, wherein the illuminator comprises infrared lighting.

13. The method of claim 1, wherein processing at least one of said plurality of images comprises:
aligning the plurality of images over time;
selecting a subset of said plurality of images without artifacts; and
combining the selected subset of images to produce a single image of the iris.

14. An apparatus for performing iris recognition from at least one image, comprising:
a plurality of cameras used to capture a plurality of images of a subject where at least one of said images contains a region having at least a portion of an iris; and
a processor for processing at least one of said plurality of images to perform iris recognition.

15. A computer-readable medium having stored thereon a plurality of instructions, the plurality of instructions including instructions which, when executed by a processor, cause the processor to perform the steps of a method of performing iris recognition from at least one image, comprising:
using a plurality of cameras to capture a plurality of images of a subject where at least one of said images contains a region having at least a portion of an iris; and
processing at least one of said plurality of images to perform iris recognition.

16. A method of forming a single image containing an iris from a plurality of images containing at least a portion of said iris, comprising:
aligning the plurality of images over time;
selecting a subset of said plurality of images without artifacts; and
combining the selected subset of images to produce a single image of the iris.

17. The method of claim 16, wherein said single image is selected from said plurality of images in accordance with a quality measure.

18. The method of claim 16, wherein said single image of the iris is formed using a mosaic of the plurality of images.

19. An apparatus for forming a single image containing an iris from a plurality of images containing at least a portion of said iris, comprising:
means for aligning the plurality of images over time;
means for selecting a subset of said plurality of images without artifacts; and
means for combining the selected subset of images to produce a single image of the iris.

20. A computer-readable medium having stored thereon a plurality of instructions, the plurality of instructions including instructions which, when executed by a processor, cause the processor to perform the steps of a method of forming a single image containing an iris from a plurality of images containing at least a portion of said iris, comprising:
aligning the plurality of images over time;
selecting a subset of said plurality of images without artifacts; and
combining the selected subset of images to produce a single image of the iris.
